(19) United States
(12) Patent Application Publication
(10) Pub. No.: US 2007/0117515 A1
(43) Pub. Date: May 24, 2007

(54) Burst processor method and apparatus

(75) Inventors: John C. Sinibaldi, Pompano Beach, FL (US); Conrad Smith, Fort Lauderdale, FL (US); Nick Glantzis, Deerfield Beach, FL (US); Geeta Pasrija, San Jose, CA (US); Luis Llorens, Lighthouse Point, FL (US)

Correspondence Address: Joseph R. Englander;Christopher & Weisberg, P.A., Suite 2040, 200 East Las Olas Boulevard, Fort Lauderdale, FL, 33301, US

(73) Assignee: SR Technologies, Inc.

(21) Appl. No.: 11/286,502

(22) Filed: Nov. 23, 2005

(51) Int. Cl. H04B 17/00

(52) U.S. Cl. 455/67.11

(57) ABSTRACT

A system and method for processing a wireless burst transmission. A sensor measures the energy of the wireless burst transmission. A first amplifier is in electrical communication with the sensor. A second amplifier is in electronic communication with the sensor. The first amplifier and the second amplifier are initially enabled and are selectively disabled based on an energy measurement from the sensor.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to wireless communications, and in particular to a burst processor and a method for wireless communications.

### BACKGROUND OF THE INVENTION

The invention applies to a system that receives data modulated into bursts of energy, such as a burst modem. Such systems can be found, for example, as part of satellite communication systems. In wireless, e.g., satellite communications or monitoring systems, data is collected from mobile earth stations (MES's) or terminals located at various distances from the receiver portion of the system. These wireless communications systems may employ a registration channel through which all terminals will initiate communication. These systems may also employ traffic channels through which communication data is sent and received. In addition, such systems may use an asynchronous, e.g. ALOHA, mode for communication. Such systems require that the receivers quickly and accurately detect or identify the type of burst received in a noisy environment to facilitate subsequent processing. However, prior art receivers may not accurately, quickly and efficiently detect a burst received, or may not be able to receive bursts from a plurality of terminals with great variance of range or strength from the receiver. It is therefore desirable to have a system which allows a receiver to quickly and efficiently detect the burst used by an MES to communicate with a satellite, and to perform signal correction on the burst accordingly. Exemplary types of bursts include registration bursts, system information or control bursts, data and voice traffic bursts.

Typically, when a receiver receives a burst from a terminal, whether for registration or communication, the burst signal energy is not known. Where signal strength is too high for a receiver, clipping or saturation of important signal data may occur. Where signal strength is too low, data may be lost in the signal noise.

Existing receivers detect whether the signal power is too high and then attenuate line amplifiers to obtain the data. However, the power of any received burst is not correlated to the power of subsequent bursts that are received from various terminals that are positioned at various distances from the receiver. Prior art systems adjustment of gain after a load burst from a close terminal may result in missing a subsequent weak burst from a distant terminal. Also, prior art receivers attenuate line amplifiers too slowly to be practicable. Where multiple bursts from multiple MES's to a satellite are made of varying strengths or from varying distances from a receiver, valuable data may be lost from a burst received by a prior art receiver receiving those bursts. In addition, there is data loss where there is an improper or delayed change in amplification of the signal received by the receiver. Also, prior art systems do not have accurate and quick signal correction for bursts affected by analog signal gain.

It is desirable to have a system that uses a plurality of pre-activated low noise amplifiers (“LNAs”) and applies signal correction to an attenuated received burst to quickly and efficiently adapt to changing signal conditions to avoid data loss.

Furthermore, bursts themselves may not be detected because current processors are not able to react quickly enough to varying signal strengths. Current systems lack an efficient way to maximize sensitivity over a range of energies and have a fast enough reaction time to receive data while minimizing losses. It is therefore desirable to have a system which uses a plurality of pre-enabled LNAs to help obtain the maximum amount of data from a received signal where the signal strength is unknown.

In addition, receivers which receive bursts after detection based on energy level need a way to compensate for the dynamic change in the noise floor of the radio receiver. The noise floor can vary based on temperature of the unit. Further, wideband interference such as from code division multiple access (“CDMA”) communications will change the effective noise when no signal is present. A solution is needed to track the noise floor in order to create an adaptable energy threshold that will be used to detect the presence of a burst.

### SUMMARY OF THE INVENTION

The receiver may have a programmable digital signal processor, super-heterodyne receiver circuitry, a plurality of low noise amplifiers (LNAs), analog to digital converter and a digital data processor such as a field programmable gate array (FPGA) with dual port memory. A plurality of LNAs are initially enabled for maximum sensitivity. The FPGA logic maintains a running energy measurement. If the measured energy exceeds a given threshold, a first LNA is disabled. If a higher threshold is surpassed, another LNA is disabled. The disablement may be completed in less than 2 symbols of data which may be corrected by an error correction mechanism. The present invention provides for reception and increased data obtainment over a large dynamic range.

Also, an algorithm is presented that used by the DSP can detect the presence of a burst with a varying noise floor. This algorithm will use an adaptable threshold that will be set to several db of energy above the noise floor. Energy from a burst will be detected is it is above the threshold. Calibration of the receiver will be performed to correct for changes in the noise floor and hence burst detection threshold.

According to one aspect, the present invention provides a system for processing a wireless burst transmission in which a processor measures the energy of the wireless burst transmission. A first receiver amplifier is in electrical communication with the processor. A second receiver amplifier is in electronic communication with the processor. The first receiver amplifier and the second receiver amplifier are initially enabled and are selectively disabled based on an energy measurement from the processor.

In accordance with another aspect, the present invention provides a method for processing a wireless burst transmission in which the energy of the wireless burst transmission is measured. A first receiver amplifier and a second receiver amplifier are initially enabled. The first receiver amplifier and the second receiver amplifier are selectively disabled based on the energy measurement.

In accordance with still another aspect, the present invention provides a machine readable storage device having stored thereon a computer program for processing a wireless burst transmission. The computer program comprises a set of instructions which when executed by a machine causes the machine to perform a method in which the energy of the wireless burst transmission is measured. A first receiver amplifier and a second receiver amplifier are initially enabled. The first receiver amplifier and the second receiver amplifier are selectively disabled based on the energy measurement.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a schematic diagram of a system incorporating the present invention;

FIG. 2 is a schematic diagram of the RF receiver of FIG. 1 constructed in accordance with principles of the present invention;

FIG. 3 is a schematic diagram of the architecture of the digital subsystem of the present invention;

FIG. 4 is a schematic block diagram of the data processor of FIG. 3, used to process TDMA signals;

FIG. 5 is a frame diagram of time division multiplexing (TDM) for a wireless or satellite communications system indicating registration and traffic channel timeslots and frames;

FIG. 6 is a schematic diagram of a data scaling block of the invention;

FIG. 7 is a schematic diagram of an energy detect block for TDMA signals of the invention;

FIG. 8 is an example of a status diagram of the LNA bits of the invention;

FIG. 9 is another example of a status diagram of the LNA bits of the invention;

FIG. 10 is a diagram of a received burst signal as an LNA is disabled;

FIG. 11 is a diagram of a received burst signal as an LNA is disabled and signal correction has been applied to the signal;

FIG. 12 is a schematic diagram of a DC offset block constructed in accordance with the principles of the present invention;

FIG. 13 is a block diagram of the data processor of the invention arranged to process asynchronous mode signals;

FIG. 14 is a flow chart of the data signal processor for asynchronous mode processing for the invention;

FIG. 15 is a flow chart of the assembly of a burst within the circular buffer in the process flow for the data signal processor for asynchronous mode processing for the invention;

FIG. 16 is a flow chart of the assembly of a burst within the circular buffer in the process flow for the data signal processor for asynchronous mode processing for the invention; and

FIG. 17 is a flow chart of the process of demodulating a burst.

### DETAILED DESCRIPTION OF THE INVENTION

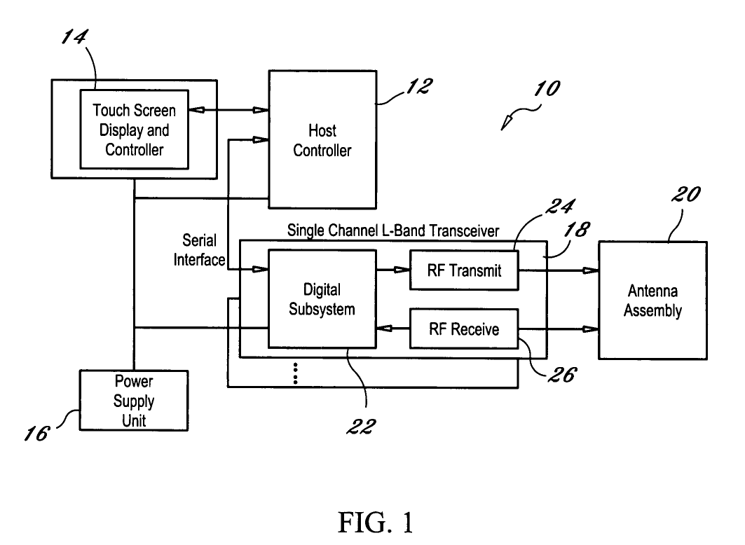

Referring now to the drawing figures in which like reference designators refer to like elements, there is shown in FIG. 1 a block diagram of a system constructed in accordance with the principles of the present invention and designated generally as “10”.

System 10 includes a host controller 12, a touch screen display and controller 14, a power supply 16, one or more single channel L-band transceivers 18 and an antenna assembly 20. Host controller 12 can be any computing device capable of controlling the other elements of system 10 and provide interfaces to other devices. For example, host controller 12 can be a general purpose computer having volatile and non-volatile storage devices, input/output interfaces, e.g., Ethernet and/or USB interfaces, central processing unit, etc., and is programmed to carry out to functions described herein. As shown in FIG. 1, host controller 12 is also interconnected with touch screen and display controller 14 and single channel L-band transceivers 18 using, for example, the above-described input/output interfaces or any other known communication method.

Touch screen display and controller 14 allows a user to configure and operate system 10. Touch screen display and controller 14 includes those components needed to support such operation as may be known in the art, such as touch screen panels, microcontrollers, interface electronics and the like. Touch screen display and controller 14 is in electrical communications with host controller 12. Of course, although FIG. 1 shows touch screen display and controller 14, it is contemplated that other input methods can be used such as a keyboard, mouse and/or graphical user interface and combinations thereof.

Power supply unit 16 can be any device capable of powering one or more of host controller 12, touch screen display and controller 14 and single channel L-band transceivers 18. Exemplary power supplies include batteries, power inverters/converters, etc.

Single channel L-band transceivers 18 are arranged to wirelessly transmit and receive a single channel. Each single channel L-band transceiver 18 includes digital subsystem 22, radio frequency (“RF”) transmit unit 24 and RF receive unit 26. Digital subsystem 22 and RF receive unit 26 are described below in detail. RF transmit unit 24 is any suitable L-band transmitter.

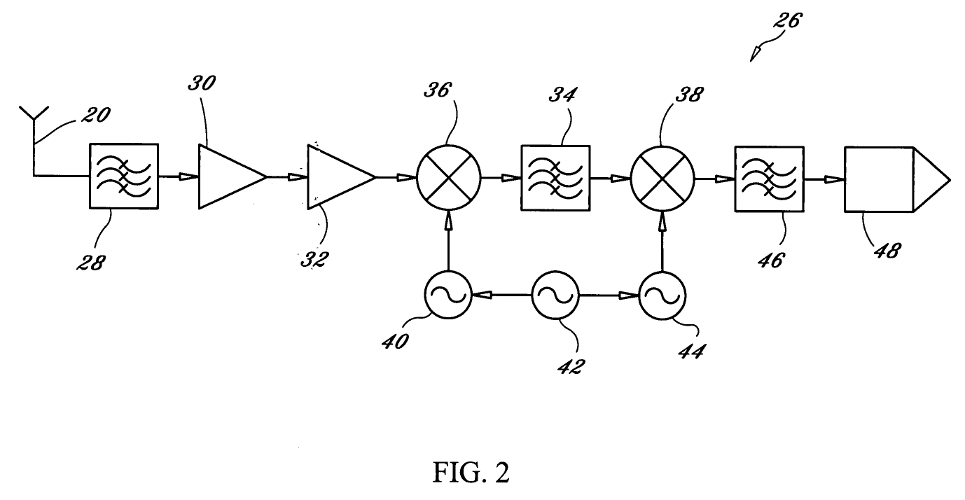

FIG. 2 is a schematic diagram of an RF receiver 26, specifically a radio tuning and down-conversion subsystem, constructed in accordance with principles of the present invention. The diagram illustrates the passage of a signal from its reception at antenna 20. Once received, the signal passes through a filter 28 such as a tunable band pass filter. As shown, the filter 28 may be one that allows passage of a signal in the range of 1626.5 to 1660.5 MHz, so that the signal from typical satellite communications MESs may be processed. The signal then may pass through a first Low Noise Amplifier (LNA) 30 and a second LNA 32. Each LNA 30, 32 or both LNAs 30, 32 may be in electronic communication with an automatic gain controller (AGC) (not shown). The LNAs are initially in an active state, as are any AGCs. The LNAs/AGCs are arranged to provide a signal boost of approximately 16 dB each. However, there may be an effective attenuation of 40 dB if two LNAs are used and both are deactivated. The processing of data to deactivate and reset the LNAs is detailed below.

After the signal is received it is down converted. During down conversion, a filter 34 isolates the received signal in between each down conversion step. The down conversion may be accomplished by passing the signal through a series of mixers 36 and 38, and filter 34 used in conjunction with signal generators 40, 42, and 44. Again, the signal generators may be optimized to accommodate existing satellite communications systems. For example, the reference signal generator 42 may be approximately 19.44 MHz. One comparison generator 40 may be tunable for intermediate frequencies of between approximately 1846.5 and 1880.5 MHz. A second signal generator 44 may generate a signal at approximately 220.1 MHz for fixed downconversion to 75 KHz. The signals generated by the signal generators may be varied to interpret signals at different frequencies. Additional signal generators and mixers may be used to obtain the optimum portion of a received signal for interpretation.

The downconverted signal is then passed through an anti-alias filter 46 and then fed to an Analog to Digital Converter (ADC) 48. Having passed through the ADC 48, the signal frequency is at a sample rate that is optimized for retrieval of the data from the received signal for use by the digital baseband subsystem.

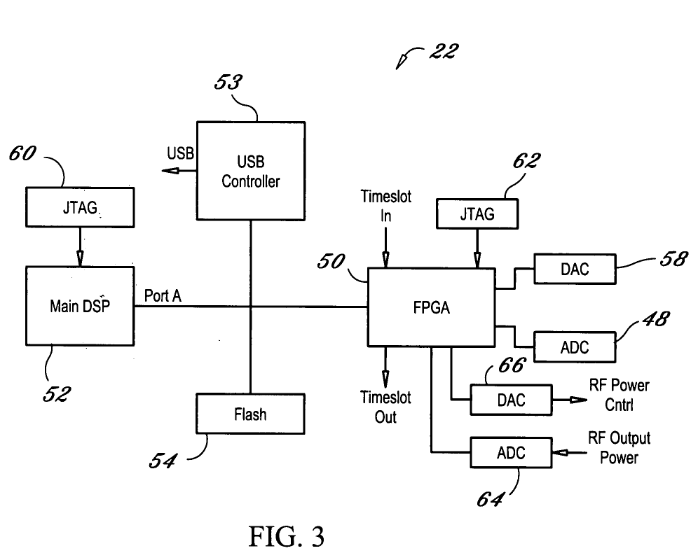

FIG. 3 is a schematic diagram of the architecture of digital subsystem 22 of a single channel L-band transceiver. After the signal has been processed through the ADC 48, it enters data processor 50. The data processor 50 may be implemented with a Field Programmable Gate Array or an equivalent semiconductor device. The signal is then passed to a digital signal processor (DSP) 52. Error correction and demodulation algorithms may be located in memory 54 such as a FLASH memory module or equivalent structure in electronic communication, and used by the DSP 52. However, these algorithms may alternatively be incorporated in the data processor 50 or incorporated into other structures as is known in the art. The data from the signal and the settings for the system 10 may then be accessed or otherwise manipulated by a controller 53 such as a USB controller or equivalent device for communication to host controller 12. Signal data may also be sent from processor 50 to a Digital to Analog Converter (DAC) 58 for other purposes including subsequent wireless transmission of data. Debugging tools 60 and 62, such as those approved by JTAG, may be used to ensure proper function of DSP 52 and data processor 50, respectively. The power of the signal entering system 10 is converted to a digital signal by ADC 64. This power measure can be used to control the analog power amplifier of RF transmitter 18 via the DAC 66. As noted above, the converted signal leaving digital subsystem 22 passes through DAC 58. The sample rate may be 234 KHz. A burst with a symbol rate of 23.4 KHz can therefore be received for a fixed ten samples per symbol.

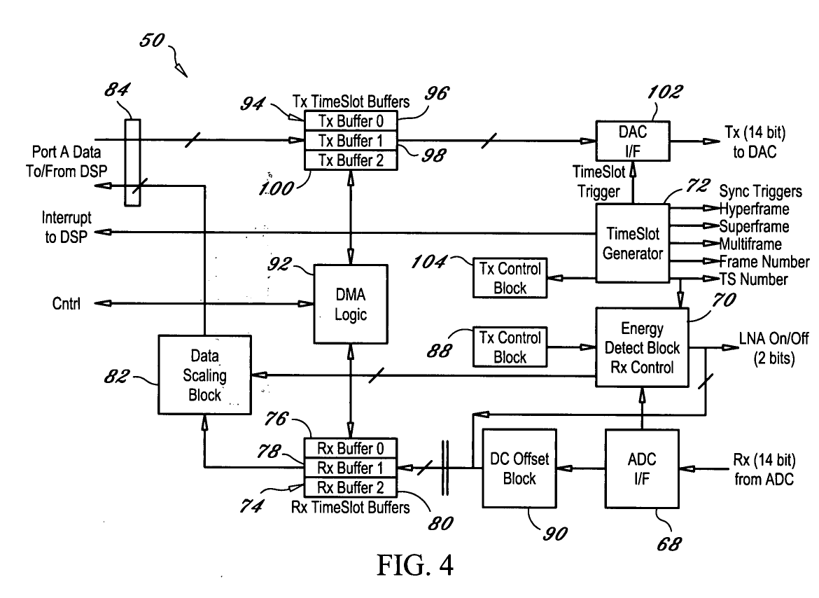

FIG. 4 is a schematic block diagram of the data processor 50 of FIG. 3 Data processor 50 is used to processing a time division multiple access (TDMA) signal. As shown, data is received ADC 48 via the ADC interface 68. The digital signal is then passed through energy detection block 70, described in greater detail below. A timeslot generator 72 provides functions including providing the timeslot number and indication that a timeslot has begun to the energy detection block 70. Received data is then collected in one or more timeslot buffers 74. As shown, three separate sequential timeslot buffers 76, 78 and 80 may be used. However, more timeslot buffers are also contemplated. A data scaling block 82 processes and scales received signals from the timeslot buffer 74 and the energy detection block 70.

Signal correction is performed on the samples of the received signal in the data scaling block 82 during a read transfer from the timeslot buffers 74 into the memory of digital signal processor 52 across Port A 84. The memory of DSP 52 may be random access memory (RAM) or its equivalent as known in the art. Data scaling block 82 and energy detection block 70 are described in greater detail below.

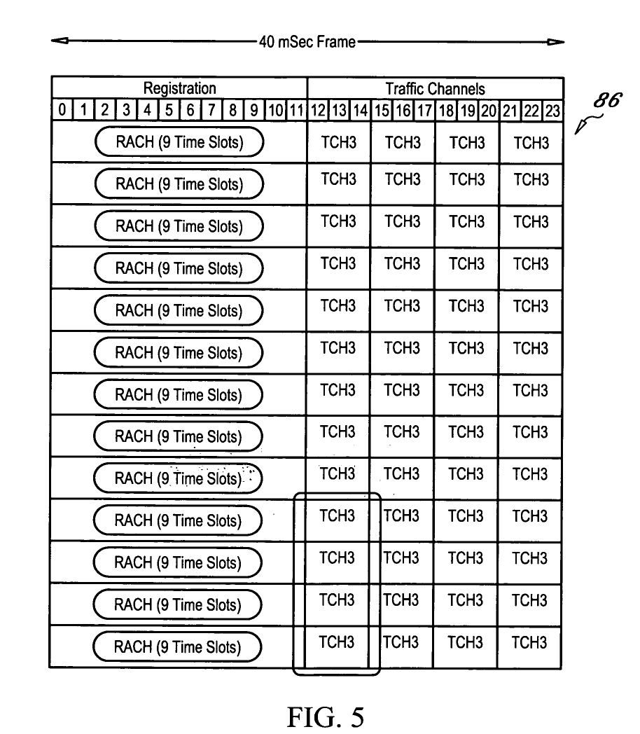

FIG. 5 is a frame diagram of time division multiplexing (TDM) for the example of a wireless or satellite communications system indicating registration and traffic channel timeslots and frames. As shown in FIG. 5, in received TDMA signals, there may be two burst scenarios: the Traffic Channel case, where the burst position is fixed, and registration or random access channel (RACH) case, where a burst may begin at any point from within the first three timeslots of the transmission frame. As described below, separate thresholds for deactivation of the LNAs are used in system 10 for RACH and for Traffic Channel bursts.

For RACH bursts, the burst is 9 timeslots in length and may occur any time within a twelve timeslot window. Thus, the RACH burst area consists of the first 12 timeslots of the uplink Frame. The automatic gain control (AGC) scanning logic is only active for the first 3 timeslots and the first 20 samples (2 symbols) of the fourth timeslot of the RACH burst, also known as the Burst Scanning Area.

Referring to FIG. 4, time-slot generator 72 creates timing information relating to the TDMA frame 86, as shown in FIG. 5. This timing information includes a time-slot number that runs from 0 through 23 and wraps back to 0 again. Based on the time-slot number and channel selected, the beginning of a particular burst type for a known satellite communication system that is typical in L-Band mobile satellite communications systems may be determined based on information from energy detect block 70. For example, as shown in FIG. 5, at time-slot number twelve, a three time-slot traffic channel burst can occur. Note that the generation of time slots may synchronize to the uplink or downlink source of the signal. The downlink source would either be a base station for cellular or satellite for satellite communication. The time-slot generator 72 may also generate the timing information locally for connecting another L-Band transceiver 18, or for using the synchronization input of a signal generator for testing.

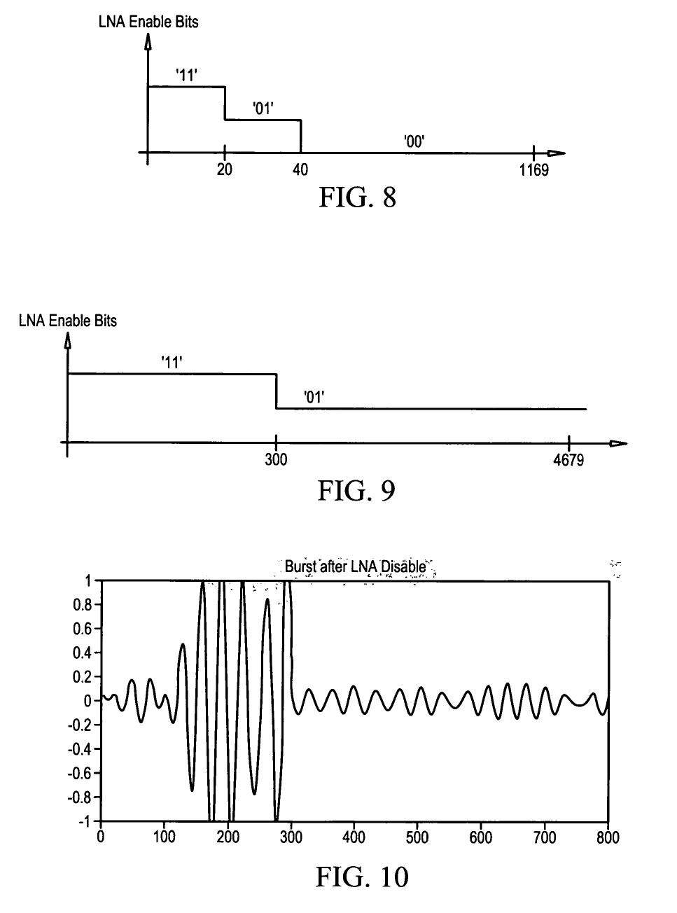

When the time-slot counter reaches zero, energy detect block 70 will automatically become configured for uplink registration burst operation. For the Time-Slot numbers 12, 15, 18, and 21, energy detect block 70 configures itself for Traffic Channel operation where the burst is aligned to each of the three time slot buffers 76, 78 and 80. Energy detect block 70 will reset a sample counter used to count the 20 sample blocks. It will also assert both LNA enable bits for maximum gain, as described below and shown in FIG. 8.

Sampled Data is read from the ADC block 48 at the proper sample rate by the ADC interface logic block 68 into the receive time-slot buffers 76, 78 and 80 in sequential fashion. A time-slot buffer is configured into three blocks, also referred to as a 3 TS buffer, of 2048 samples. In an exemplary implementation, three time slots occupy 1170 samples. However, it is contemplate that arrangement is configurable. So, for a 3 TS buffer, only 1170 of the 2048 samples are utilized. Receiver control block 88 will manage the buffer pointers to use the first 1170 locations of the buffer.

Energy detect block 70 will maintain an “Energy Value” and a 2 bit maximum attenuation value as the time-slot buffers 74 are filled. A DC offset correction block 90 will add a correction factor to the 14 bit data as each sample is written into receive timeslot buffers 74.

The 2 bit LNA On/Off State is appended to the 14 bit Received data along with another 2 spare bits for a total of 18 bits, the entirety of which are stored in the receive time-slot buffer 76, 78 and 80 for each sample. Receiver control block 88 keeps track of how much data is written into each of time slot buffers 74 before writing data into the next buffer. This is done, for example, by managing the write pointers.

Timeslot buffers 74 arranged to have three 3TS Buffers 76, 78 and 80 can therefore hold up to nine timeslots of data. But after one buffer is filled (3 of 9 timeslots) and is available for DSP 52, the time slot generator 72 will interrupt DSP 52. DSP 52 in turn programs DMA logic block 92 to transfer the three timeslots of data from timeslot buffers 74 to memory in DSP 52 for processing. The DSP memory may be intrinsic to the DSP 52 or may be separate from and accessible by the DSP 52 as is known in the art.

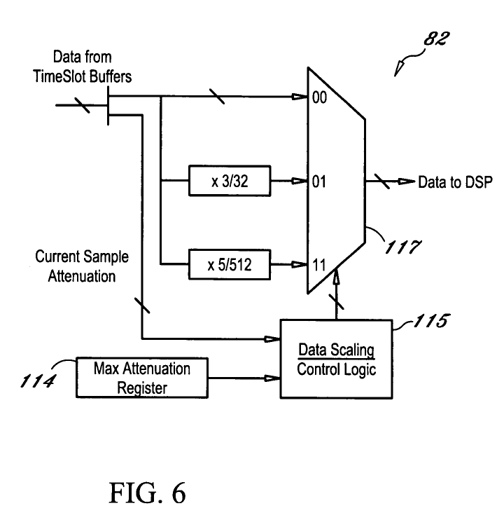

As each sample is read out of receiver time-slot buffer 72 by DMA logic 92, data scaling block 82 scales the data as described in the example shown in FIG. 6, as is described below. Note that each sample is scaled according to what the maximum attenuation was for that block and the current attenuation for that sample. This scaling process compensates for the LNA state changes controlled by the energy detect block 70 since, as LNAs are disabled, the amplitude of the received signal is decreased. The scaling and DC offset correction may be done concurrently as the DMA logic block 92 transfers data from the receive time-slot buffer 74 to DSP 52 memory to help prevent latency delay to the system.

Each time DMA Block 92 processing is completed, DSP 52 assembles the data samples into a burst in memory. In the case of a traffic channel, there is one burst per DMA block 92 and a DSP demodulation routine is called directly after the DMA block 92 processing is completed. In the case of a Registration burst, three DMAs are required to complete the burst because the burst occupies nine timeslots. Thereafter, the proper demodulation routine is called.

Thus, the LNA enable bit state is saved as the data samples are read by ADC I/F block 68 and are placed into the receive timeslot buffers 74. Then, as the LNA enable bits are read out by DMA logic 92, correction is applied to the samples as they are read from the timeslot buffers and transferred to the DSP memory by data scaling block 82 to account for the change in LNA enable bits affecting the level of the signal during the burst.

If only one LNA is disabled, all samples that occurred before the first LNA was deactivated are attenuated by 3/32. If both LNAs are disabled, then all samples that were received before the first LNA was switched off are attenuated by 5/512. Samples received between disablement of the first and second LNA are attenuated by 3/32. Note that approximations are used to simplify the design. The attenuation applied approximates the loss in gain of the received signal when the LNA(s) are disabled. The threshold values for deactivation of the LNAs are configurable by the DSP or by other means known in the art. The data block size is fixed at 20 samples for 2 symbols worth of data at a sample rate of 234 KHz. However, it is contemplated that other data block sizes may be preferred.

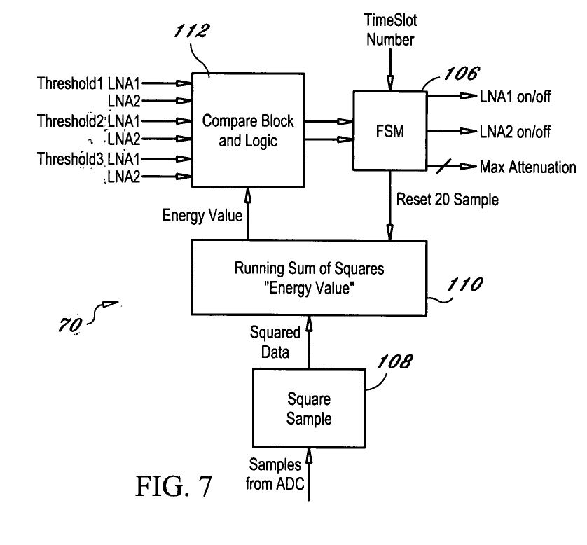

Thus, there may be four thresholds, two each for registrations and voice traffic. As shown below, there may be additional thresholds for asynchronous bursts (See FIG. 7, described below)

For Traffic Channel bursts, since the burst segment area may consist of 3 timeslots, only one scan block section with a length of 20 samples at the start of the segment area is required. At the end of the burst segment area, the LNA/AGC logic may be reset.

TDMA Mode Dataflow (Transmit)

Referring again to FIG. 4, the memory of DSP 52 stores sampled signal waveforms. These waveforms may be created by programs running on the DSP 52. DSP 52 initiates transfers of 3 timeslots of data (read by the DMA logic 92) from DMA logic 92 to transmit time-slot buffers block 94 in data processor 50. This data is then read from each of the individual 3TS Transmit Time-Slot Buffers 96,98 and 100, sample by sample at a predetermined sample rate by DAC interface logic block 102 into DAC 58, shown in FIG. 3. In one example, where 14 bits are received from ADC 48, the upper 14 bits are transmitted to DAC 58.

Also, there is a timeslot number, generated by the time-slot generator 72, associated with each 3TS Buffer 94. This timeslot number is used by transmission control block 104 to determine when to send the data to the DAC Interface 102 for transmission. Each buffer is a power of two in size. For example, each buffer is large enough for 2048 samples (two to the power of eleven). However, less than that may be used for each individual 3 timeslot buffer 98, 98 and 100.

As data is sent to DAC interface 102, the DMA Logic Block 78 is instructed by DSP 52 to transfer the next 3TS buffer of data until the entire burst has been transferred. Note that for traffic channels of known satellite communications systems, the entire burst will fit into a single 3TS block, such as Tx buffer 0 96.

Energy Detect Block

Energy detect block 70 of FIG. 4 is described in more detail with reference to FIG. 7. Energy detect block 70 monitors the energy level of 20 consecutive samples from ADC 48. The energy level of each sample is squared by square sample block 108. A sum of squares of the energy levels is maintained in sum of squares block 110 as an energy value. The energy value may be a sliding window energy calculation. After the energy value of the burst is calculated, the energy value is sent to comparison block 112 to compare the energy value with LNA thresholds to determine whether one or more LNAs are disabled for the next set of samples. The results of the comparison are communicated to FSM 106. After FSM 106 has obtained the comparison, sum of squares block 110 is reset to prepare for the next burst. The time-slot number may be used to determine when a burst begins in a TDMA frame. FSM 106 also provides a maximum attenuation value, which is a two bit LNA on/off control value set for the received burst. The maximum attenuation value is fed in to max attenuation register 114 (FIG. 6) of data scaling block 82 for signal correction of the samples as they are read out by DMA logic block 92.

Referring again to FIG. 7, If the energy of first 20 samples exceeds the threshold LNA1, then LNA1 will be disabled. If threshold LNA2 is exceeded, then LNA2 is disabled. A third set of thresholds is used support asynchronous mode.

FIG. 6 shows how the data is corrected based on how the LNAs were configured for each sample and the final LNA setting (maximum attenuation). There may be a maximum attenuation register 114 for each of the three timeslot buffers 76,78, and 80 for setting each LNA. Data scaling block 82 also includes control logic 115 to control the operation of data scaling block 82 and multiplexer 117 to assemble the 24 bit data packet for transmission to DSP 52.

FIG. 8 shows an example of the processing of a burst of a predetermined length. The value of the two LNA Enable bits is shown when processing a burst that is 1170 samples in length. The first 20 samples have both LNAs enabled. In this example, after 20 samples the LNA threshold LNA1 is passed and then a first LNA is disabled. Then, after another 20 samples the second LNA is disabled after threshold LNA2 is passed. When data is read out from the burst, max attenuation register 114 (FIG. 6) is set to ‘00’ (both disabled). Thus, the first 20 samples may be attenuated by 5/512 and the second 20 samples may be attenuated by 3/32.

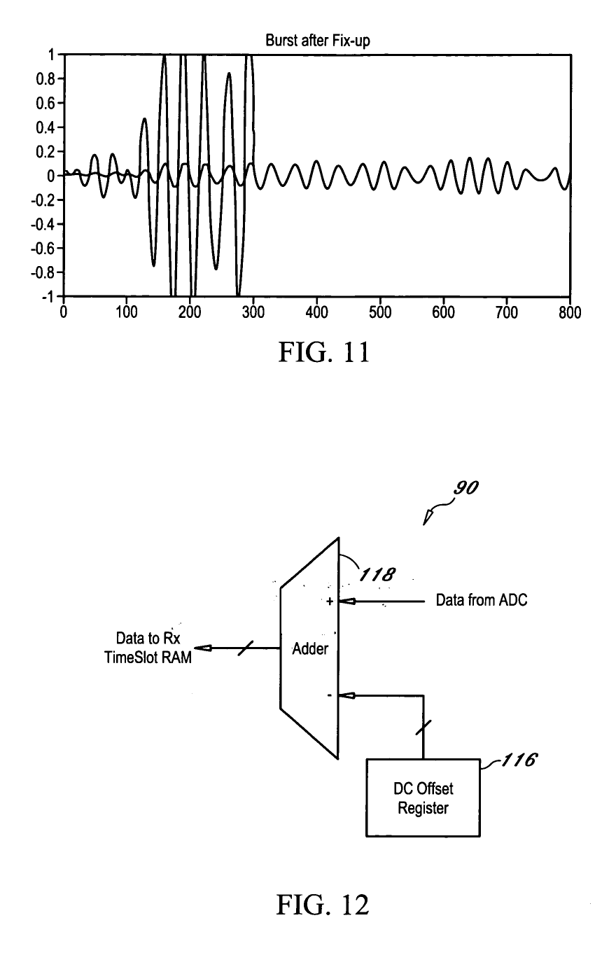

FIG. 9 illustrates another example of the processing of a burst of a predetermined length. The value of the two LNA Enable bits is shown when processing a Burst that is 3520 samples in length. The first 300 samples have both LNAs enabled. After 300 samples LNA threshold LNA1 is passed. At that point, one LNA is disabled. A graph showing the burst signal after the LNA1 is disabled is shown in FIG. 10. When data is read out, the Maximum Attenuation Value is set to ‘01’ (one disabled). Thus, the first 300 samples are attenuated by 3/32. The graph of the burst illustrated in FIG. 10 with an LNA disabled and the signal corrected (fixed up) is shown in FIG. 11.

DC Offset Correction

FIG. 12 shows the details of DC offset block 90 of FIG. 4. DC offset block 90 processes the sampled signal to remove any DC offset from the sampled signal. A known impairment in receiving a signal is from unwanted DC offset added to the signal by the receiver circuitry. The DC offset may be removed by the circuit shown. DSP 52 measures and calculates an appropriate DC offset and write it into DC offset register 116. The value of the offset is added by adder 118 to the digital signal from ADC 48.

Asynchronous Operation

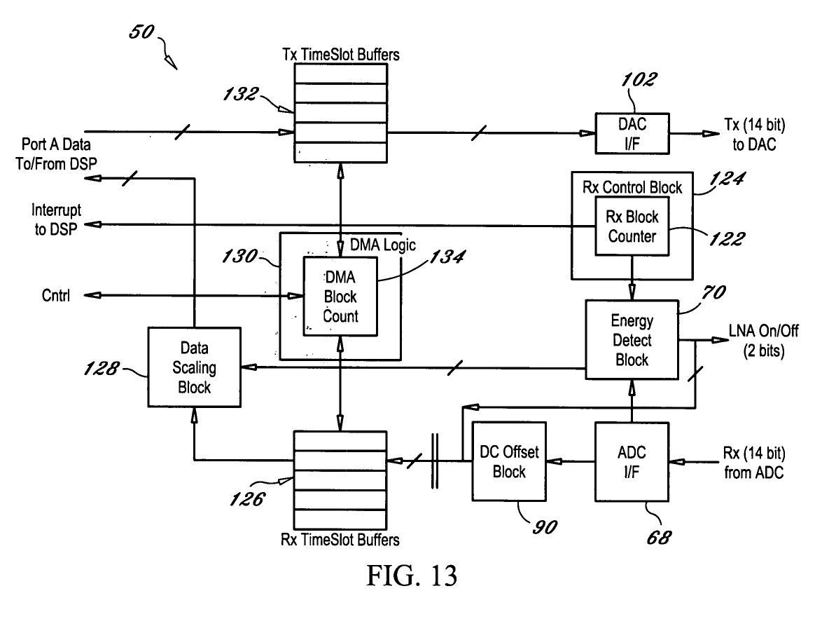

An example of a data processor 50 of digital subsystem 22 of the invention arranged to support asynchronous operation is described with reference to FIGS. 7 and 13. In this embodiment, during asynchronous operation, energy detect block 70 performs energy detection with a sliding window of 20 samples as described above. However, “instead of the ending of a block”, a receiver block counter 122 in receiver control block 124 is used to reset the maximum attenuation value, or energy value in energy detection block 70, and re-enable both LNAs in the energy detect block 70. In this embodiment, receive timeslot buffers 126 are not processed by DMA scaling block 128 and sent to the memory of DSP 52 until after a delay. The delay is long enough to allow 20 contiguous samples to have their energy measured. This allows for the boundary condition where a burst just begins before the end of a block but the LNA threshold has not been surpassed. Thus, there may be up to two data blocks ready for processing by DMA block 130 to DSP 52 at the same time. After receiver block counter 122, which may be located within energy detect block 70, reaches its programmed limit in counting samples, both LNAs may be re-enabled for maximum gain. As the LNAs are re-enabled, a maximum attenuation register within data scaling block 128 is reset at this time. The maximum attenuation register is used as before by data scaling block 128 to determine whether signal correction is needed for each sample as the sample is read by DMA logic 130.

Asynchronous Mode Dataflow (Receive)

Referring again to FIG. 13, data is obtained through an ADC interface and continuously read into sequential TS buffers 126. It may be preferred that each sequential TS buffer 132 is approximately 128 samples each. However, the use of larger buffers is also contemplated.

Energy detect block 70 will reset a sample counter used to count the 20 sample blocks and assert both LNA enable bits. Once LNA state has changed as to turn off one or both LNAs, it will maintain that state for up to the programmed burst length. Afterwards, it will reset to re-assert both LNA bits since the burst will be completed. The second LNA may be disabled in the following 20 sample window.

Sampled data is read from ADC 48 (shown in FIG. 3) at the proper sample rate by the ADC IF logic block 68 into receive time-slot buffers 126 in sequential fashion. time-slot buffers' 126 RAM may be configured into 48 blocks of 128 samples. However, this size may be altered as known in the art. Furthermore, the sample rate itself may be raised or lowered depending upon the user's purpose. The sample rate alteration may be performed at ADC I/F logic block 68 or an equivalent point in the system.

As shown in FIG. 7, energy detect block 70 essentially operates as described above. However, unlike TDMA usage, the time-slot number can not be used to determine when a burst begins. Instead this will be done by assuming that energy surpassing a threshold is the result of the beginning of a burst. A counter (not shown) within FSM 106 provides a register for resetting the energy value which is reset after processing 20 samples.

Referring again to FIG. 13 and FIG. 6, the maximum attenuation value is fed into data scaling block 82 (128) for error correction of the samples as they are read out by the DMA logic 92 (130). This applies to TDMA usage and asynchronous mode. The maximum attenuation value is maintained within energy detection block 70 as time-slot buffers 126 are filled.

In operation, the LNA On/Off State is appended to the 14 bit Received Data for a total of 18 bits that are stored in receive time-slot buffers 126, as shown in FIG. 13. The LNA On/Off State may be a 2-bit value, or may be or decreased, depending upon whether more or fewer LNAs are used. Spare bits may be appended to the LNA On/Off State for expandability. Two additional spare bits may allow an additional LNA to be used, or the spare bits may be used for other functionality as known in the art.

The received signal control block 124 keeps track of how much data is written into each sequential buffer 132 before writing into the next buffer. This is done by managing the write pointers. In asynchronous mode, the entire buffer 132 can be utilized.

After a buffer is filled and is available for DSP 52, the received signal control block 124 will interrupt DSP 52. DSP 52 in turn programs DMA logic block 130 to transfer this data to the internal memory of DSP 52 for processing.

As each sample is read out of received signal time-slot buffer 126 by DMA logic block 130, data scaling block 128 scales the data as described in the example shown in FIGS. 9-11. The scaling is based on the max attenuation setting and each sample's appended LNA state. This would only be needed for the first one or two blocks of a burst.

Each sample is scaled according to the maximum attenuation value for that burst and the current attenuation for that sample. This scaling process compensates each sample for the LNA state changes controlled by energy detect block 70, since as LNAs are disabled, the amplitude of the receive signal is decreased.—This arrangement provides a larger dynamic range from receiving bursts at various distances from the receiver.

The scaling and DC offset correction is done as the DMA logic block 130 transfers data from the received signal time-slot buffers 126 memory to the DSP 52 memory without adding latency delay to the system. DMA block counter 134 indicates the number of blocks ready to be processed by DMA logic block 130. While the present example results in having one or two data blocks ready for processing by DMA logic block 130, more data blocks may be prepared in other configurations as is known in the art. Also, in asynchronous operation, DC offset block 90 operates as described above.

DSP Operation in Asynchronous Mode

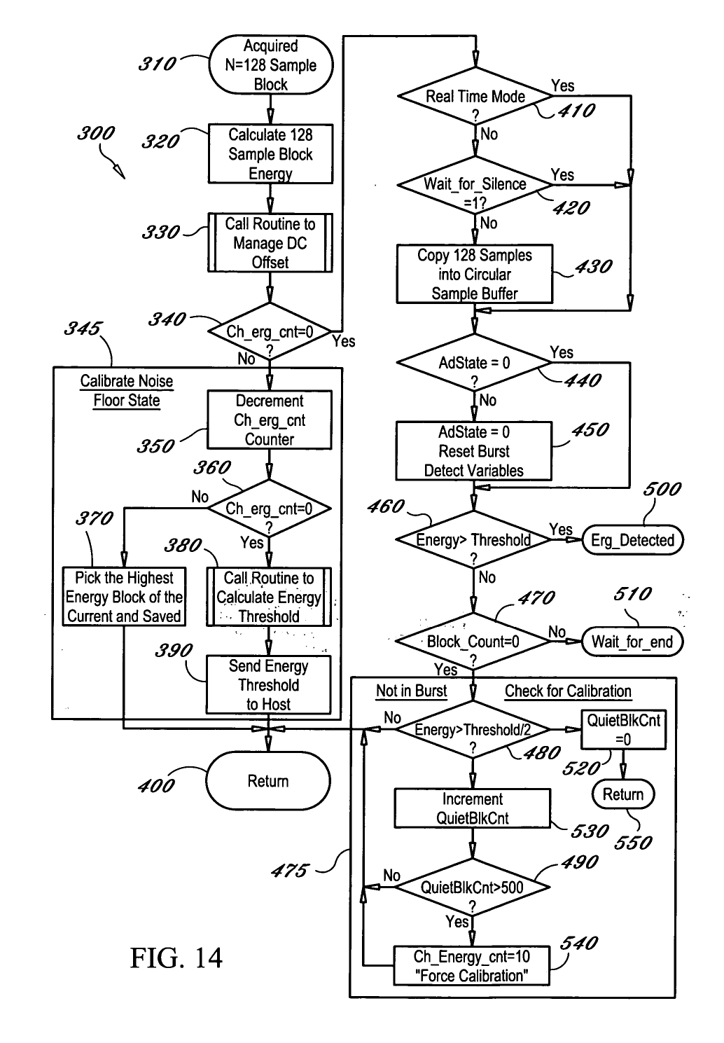

After DMA logic block 130 has completed its processing, DSP 52 in response to an interrupt, calls a data block process routine. The process, shown as data block process routine 300, is described with reference to the flow chart shown in FIGS. 14-17. When each DMA logic block 130 is completed with processing, DSP 52 dispatches a data block process routine 300 for an energy burst of a predetermined length. This routine processes one block of data, having a predetermined number of samples, at a time. Routine 300 maintains an adjusted noise floor of the radio hardware to allow an adaptive threshold for burst energy detection. The radio itself is a major source of noise. In addition, interference from other spread spectrum, e.g. CDMA, signals is a source of noise. When an energy burst of proper length is detected, the corresponding demodulation routine is then called.

Data block process routine 300 supports “capture and hold” demodulation where the demodulator is called after the complete burst is buffered. The buffer is sized to be large enough to hold the entire burst. For example, an 84 milli-second burst will require the buffering of 19,656 samples. Also the present invention supports “demodulation on the fly”, also referred to as real-time demodulation. In real-time demodulation, as a section of a burst is received, the demodulator is called to process part of the burst. This method of demodulation may be useful for long bursts which are larger than the size of the buffer. A burst of 100 milli-seconds in length or larger may merit real time demodulation. However, larger buffers may be used where “capture and hold” demodulation is preferred. Also, note that decimation may be used by DSP 52 to reduce the amount of samples needed. This in effect will reduce the sample rate and the number of samples needed to store the burst.

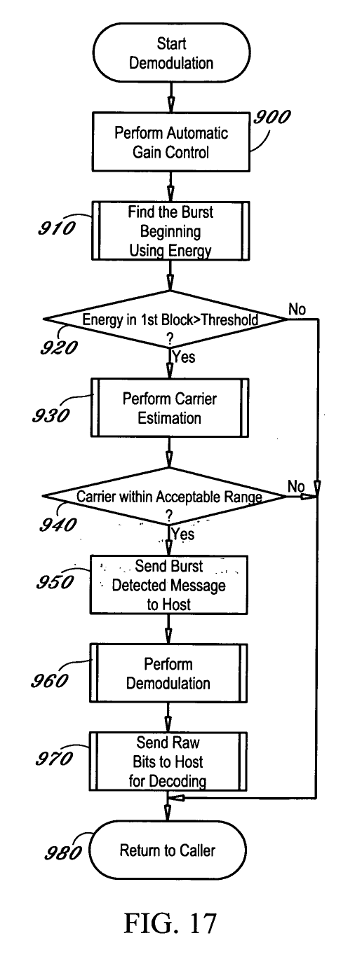

Data is transferred from data processor 50 into the memory of DSP 52 in N sample blocks (step 310). Data may be transferred in 128 samples. The process flow occurs each time another N block of samples has been transferred from DMA logic block 130 into the memory of DSP 52. This data is copied into a circular buffer for further processing by the demodulation routine shown in FIG. 17.

Data Block Process

In step 320, DSP 52 calculates a sum of squares for the energy value of the 128 samples. The DC offset may then be calculated in step 330, where the DC Offset register 116 is accessed and adjusted. A determination of whether the noise floor of the radio has been calculated is then made in step 340.

If the noise floor has not been calculated, then the process flow enters the calculation of the noise floor state in step 345. In step 345, the steps of the calculation are shown as steps 350 through 400. In calculating the noise floor, an energy counter register is decremented in step 350. This register, if non-zero, is used to indicate if calibration is in progress. A non-zero value indicates how many blocks remain to be calibrated. The value is compared with zero in step 360. If the value is zero, then the energy threshold is calculated in step 380. Of note, in step 480, the value of the energy threshold is used to determine whether a burst has been detected over the noise floor. The value of the energy threshold is also sent to host controller 12 (step 390). In step 400, the process ends and the call returns. Process 300 is called from a “Receive Thread” that is scheduled by the DSP 52 kernel (OS). As such, the return blocks in the flow charts indicate returning to the thread. In this case, the thread is activated when the DMA of the block of samples to the memory of DSP 52. If the value of the energy counter is not zero, then the value of the strength of the highest energy block of the sample block is saved in step 370 and calibration continues.

If the noise floor has been calculated in step 345, then a check is made to determine whether the system 10 is processing the received signal in real-time mode (step 410). In step 410, if the system is in real-time mode, the data is not copied to a circular sample buffer (step 430) since the demodulator will process a block at a time. Also, in step 420, the data is not copied to the circular sample buffer if the system is waiting for silence at the end of the burst. Otherwise, the data is copied into a circular buffer in step 430 to capture the entire burst in the memory of DSP 52. Steps 440 and 450 determine the value of the AdState variable, and if/when variables are reset if a burst has been received. AdState is a state variable used to indicate that variables have been initialized. After a burst is completed, this variable is set (see step 770, described below). Other variables include block counter, readying for next burst and other variables used to implement the functions described herein. On the next entry, variables can be re-initialized to process the next burst detection.

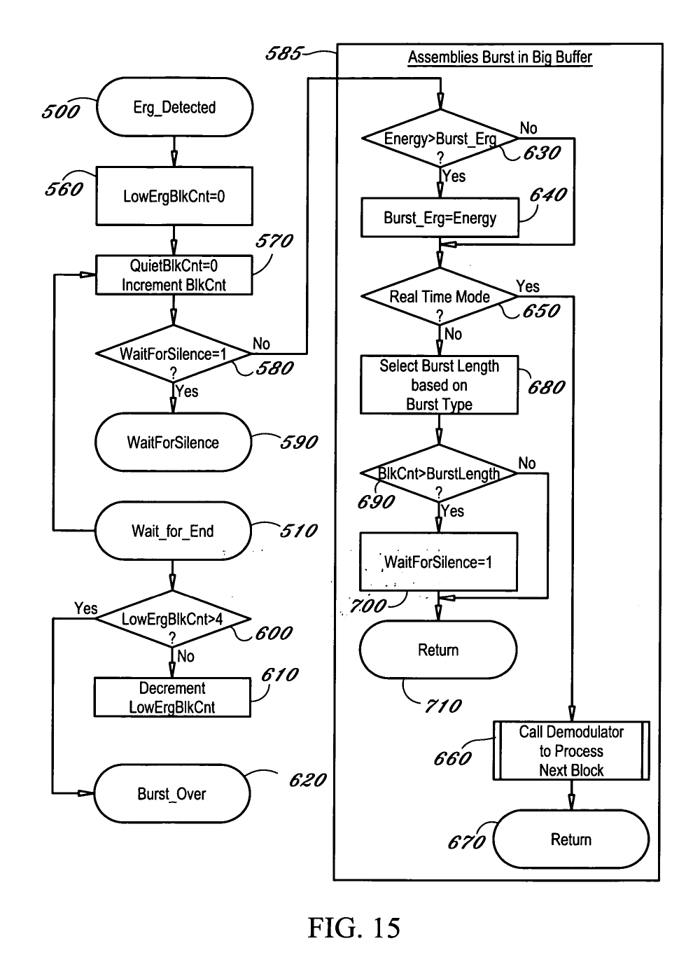

In step 460, the current block energy is compared with the adaptive threshold used for burst detection. If the energy value is above the threshold, step 500, detailed in FIG. 15, is entered where the control flow waits for the end of burst to be reached. If the energy value is below the threshold, and the block count is zero (step 470), meaning no blocks with energy above the energy threshold were found, i.e., a burst is not in progress, the data is checked to see if the energy is above ½ the threshold (step 480). Half of the threshold value is used to determine if the threshold is too high. If it is, very weak bursts may not be detected. While half of the threshold is used herein, it is understood that any other convenient value can be used to ensure that weak bursts are not missed. If the energy is not above ½ of the threshold value, then the noise floor is recalibrated (step 475).

Step 475 determines if recalibration is needed as may be needed if background noise goes away. If recalibration is needed, variable Ch_Energy_Cnt is set to 10 (step 540) causing step 345 to be performed. The threshold value may be configured to be within 6 dBm of the noise floor to obtain efficient obtainment of information from the burst. After recalibration, process flow returns to the receive thread (the routine activated after DMA transfer completed). If the energy value is below the threshold, and Block_Count is not zero (step 470), process flow then waits for the end of the burst (step 510).

At step 500 the system is receiving energy above the threshold and is waiting for the end of energy reception to see if it represents a valid burst. When a burst is completed, LowErgBlkCnt is set to zero at step 560. QuietBlkCount is set to zero (step 520) and BlkCnt is incremented in step 570. The purpose of changing the value of the variables is discussed below. At step 580, if the process is not waiting for silence flow proceeds to assemble the burst in a circular buffer (step 585) which is typically an area within the internal memory of DSP 52. Of note, the data is copied in step 430, while step 585 is performed while data is copied in step 430. If the value of WaitforSilence is one, then process flow waits for silence at step 590. Thus, WaitForSilence is set when the burst of energy reaches desired length but is still not below the threshold. In other words, an amount of data needed for the expected burst length has been assembled, but since energy is still above the threshold, we wait for the burst to fall below the threshold. At steps 630 and 640, the value of energy is reset to the value of burst energy where burst energy exceeds the present value of the energy.

The above-listed variables are now described as follows:
QuietBlkCnt is used to detect very long quiet periods and to indicate the need for a recalibration
BlkCnt—Indicates the number of contiguous blocks with energy>Threshold
ExtraBlkCnt—After BlkCnt surpasses the programmed burst length, WaitForSilence State is set. This count increments to allow 20 more blocks to be appended to the receive buffer before demodulation.
LowErgBlkCnt—When BlkCnt is Not Zero, and the energy of blocks is below the threshold, this variable is incremented to allow for 4 silent blocks to pad the end of the burst before demodulation.
WaitForSilence—This is set when the length of continuous energy that is above the threshold exceeds the desired burst length. In such a case, a burst has been found or the noise floor has increased above the threshold, indicating the possibility that recalibration may be needed.

If process flow is waiting for the end of a burst at step 510, then, as shown in step 600 (FIG. 15), if LowErgBlkCnt is less than 4, it is decremented in step 610 and process flow returns to step 570. If the value of LowErgBlkCnt is greater than 4, then the burst is then determined to be completed, as shown in step 620.

It is then determined whether system 10 is operating in real-time mode 650. Real time mode may be used where a burst length is especially long. The real-time or “hold and capture” modes may be selectable or preselected for the system 10. If system 10 is operating in real time mode, the demodulator is next called to process the block of data in step 660. After the demodulator has been called, the process returns (step 670). If the processing is operating in “capture and hold’ mode, a known preconfigured burst length is selected for comparison to the burst in step 680. In step 690, the energy burst length is compared to given configurations of bursts to determine if the burst is a known burst type. If the burst surpasses the given burst length, then in step 700, WaitForSilence is set to 1 to have the process wait for the burst energy to go below the threshold value before the demodulator is called. The process flow then returns to the main receive thread at step 710.

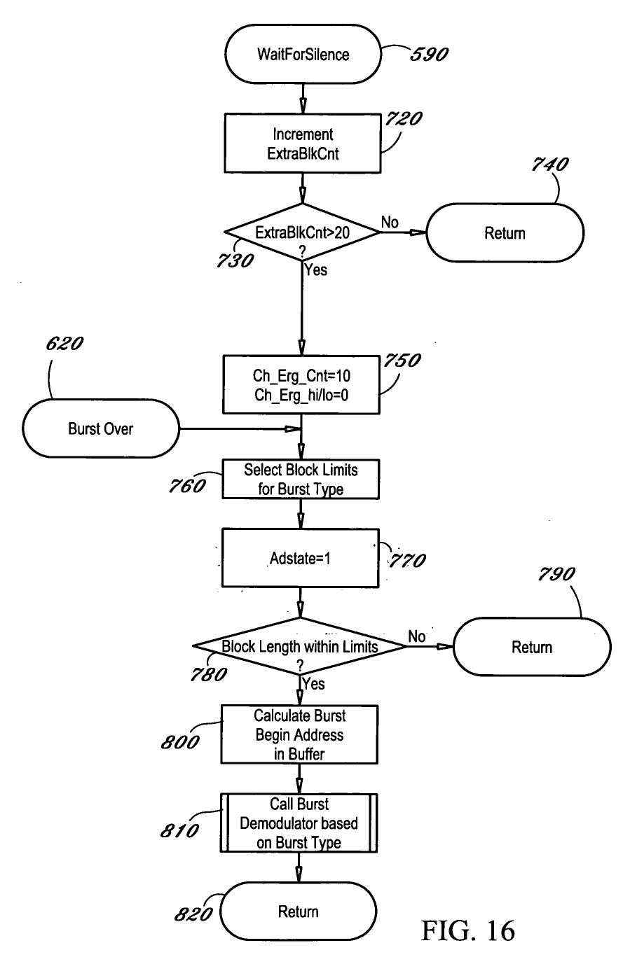

When control flow has passed step 510 and the LowErgBlkCnt counter has reached 4, enough silence after the programmed length of the burst is captured has passed to allow for demodulation, and the burst is determined to be over (step 620). As control passes either step 590 or step 620, the process flow passes as shown in FIG. 16.

In step 720, variable ExtraBlkCnt is incremented. If ExtraBlkCnt is not greater than 20 (step 730), the process returns (step 740). If ExtraBlkCnt is greater than 20, Ch-Erg_cnt is set to “10” and Ch_Erg_hi/lo is set to 0. The block limits are selected based on the burst type (step 760). At this point, an energy burst has been detected. Based on its length. A determination can be made as to whether the energy burst is from a valid burst. AdState is set to one (step 770). If the block length is not within predetermined limits, the block is not valid and the process returns (step 790). Optionally, recalibration can be forced (step not shown) by setting ch_erg_cnt to 10.

If the block length is within the limits as determined in step 760 (step 780), the burst starting address in the buffer is calculated (step 800) and the burst demodulator corresponding to the burst type is called (step 810). The process then returns (step 820).

Demodulation Example

Demodulation of a signal (from step 810) is described with reference to FIG. 17. This demodulation process occurs in both the synchronous and asynchronous modes.

Once the complete burst has been assembled in the buffer, automatic gain control may be used to adjust the burst level in the memory of DSP 52 (step 900). Then the actual burst beginning, within the 128 sample block, is determined (step 910). A further threshold check of the burst energy is performed for the first block of data (step 920). The burst is discarded if energy is below this threshold. If the burst is above the predetermined threshold, carrier estimation is performed on the burst in the memory of DSP 52 (step 930). The carrier is also evaluated to determine whether it is within an acceptable range (step 940). If the frequency is outside acceptable range the burst is discarded. If the carrier is within the acceptable range, a message is sent to host controller 12 to indicate that a burst has been detected (step 950). The energy and frequency of this burst is also passed back to host controller 12 for statistical purposes.

Demodulation occurs in step 960. After demodulation the raw recovered data is decoded (step 970) and the process returns (step 980). This decoding may be performed by DSP 52 or may be done by host controller 12. The choice of where decoding is performed depends on the available resources of the system such as memory and processor speed. If decoding is done on host controller 12, the raw data is sent to host controller 12 using the USB interface via the USB device driver code, which exists within DSP memory that programs the USB controller 53.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A system for processing a wireless burst transmission, comprising:
a processor measuring the energy of the wireless burst transmission;
a first receiver amplifier in electrical communication with the processor; and
a second receiver amplifier in electronic communication with the processor, the first receiver amplifier and the second receiver amplifier being initially enabled and being selectively disabled based on an energy measurement from the processor.

2. The system of claim 1, wherein the first receiver amplifier is disabled at a first energy threshold.

3. The system of claim 2, wherein the second receiver amplifier is disabled at a second energy threshold.

4. The system of claim 1, wherein the processor includes:
an energy detector; and
a receive buffer, the receive buffer storing signal data corresponding to the wireless burst transmission, the energy detector maintaining an energy value and a maximum attenuation value based on the stored signal data, the maximum attenuation value being used to control the operation of first receiver and second receiver amplifiers.

5. The system of claim 4, wherein the signal data is arranged into a plurality of timeslots, and wherein the receive buffer is arranged to buffer a plurality of timeslots, the energy value being based at least in part in the energy value of the plurality of timeslots.

6. The system of claim 4, further comprising a DC offset component in electrical communication with the energy detector and the at least one receive buffer, the DC offset component processing the signal data to remove DC offset there from.

7. The system of claim 4, further comprising a digital signal processor, the digital signal processor demodulating the signal data.

8. The system of claim 7, wherein the signal data is scaled prior to demodulation, the scaling being based on the maximum attenuation value for the wireless transmission burst and an attenuation value for a current sample of the signal data to be demodulated.

9. The system of claim 1, wherein an adaptive threshold is used to determine the detection of a wireless transmission burst, the threshold taking a noise floor of the wireless transmission into account, wherein the processor recalibrates the noise floor to reset the adaptive threshold if the threshold is not within a predetermined range of the noise floor.

10. The system of claim 9, wherein the predetermined range is substantially 6 dBm.

11. A method for processing a wireless burst transmission, comprising:
measuring the energy of the wireless burst transmission;
initially enabling a first receiver amplifier and a second receiver amplifier; and
selectively disabling the first receiver amplifier and the second receiver amplifier based on the energy measurement.

12. The method of claim 11, wherein the first receiver amplifier is disabled at a first energy threshold.

13. The method of claim 12, wherein the second receiver amplifier is disabled at a second energy threshold.

14. The method of claim 11, further including:
storing signal data corresponding to the wireless burst transmission;
determining an energy value and a maximum attenuation value based on the stored signal data, the maximum attenuation value being used to control the operation of first and second receiver amplifiers.

15. The method of claim 14, wherein the signal data is arranged into a plurality of timeslots, and wherein the signal data is arranged into a plurality of timeslots, the energy value being based at least in part in the energy value of the plurality of timeslots.

16. The method of claim 14, further comprising processing the signal data to remove DC offset there from.

17. The method of claim 14, further comprising demodulating the signal data.

18. The method of claim 17, further comprising scaling the signal data prior to demodulation, the scaling being based on the maximum attenuation value for the wireless transmission burst and an attenuation value for a current sample of the signal data to be demodulated.

19. The method of claim 11, further comprising:
using an adaptive threshold to determine the detection of a wireless transmission burst, the threshold taking a noise floor of the wireless transmission into account; and
recalibrating the noise floor to reset the adaptive threshold if the threshold is not within a predetermined range of the noise floor.

20. A machine readable storage device having stored thereon a computer program for processing a wireless burst transmission, the computer program comprising a set of instructions which when executed by a machine causes the machine to perform a method including:
measuring the energy of the wireless burst transmission;
initially enabling a first receiver amplifier and a second receiver amplifier; and
selectively disabling the first receiver amplifier and the second receiver amplifier based on the energy measurement.

21. The method of claim 20, wherein the first receiver amplifier is disabled at a first energy threshold.

22. The method of claim 21, wherein the second receiver amplifier is disabled at a second energy threshold.

23. The method of claim 20, further including:
storing signal data corresponding to the wireless burst transmission;
determining an energy value and a maximum attenuation value based on the stored signal data, the maximum attenuation value being used to control the operation of first and second receiver amplifiers.

24. The method of claim 23, wherein the signal data is arranged into a plurality of timeslots, and wherein the signal data is arranged into a plurality of timeslots, the energy value being based at least in part in the energy value of the plurality of timeslots.

25. The method of claim 23, further comprising processing the signal data to remove DC offset there from.

26. The method of claim 23, further comprising demodulating the signal data.

27. The method of claim 26, further comprising scaling the signal data prior to demodulation, the scaling being based on the maximum attenuation value for the wireless transmission burst and an attenuation value for a current sample of the signal data to be demodulated.

28. The method of claim 10, further comprising:
using an adaptive threshold to determine the detection of a wireless transmission burst, the threshold taking a noise floor of the wireless transmission into account; and
recalibrating the noise floor to reset the adaptive threshold if the threshold is not within a predetermined range of the noise floor.
